(19) United States
(12) Patent Application Publication
(10) Pub. No.: US 2008/0121240 A1
(43) Pub. Date: May 29, 2008

(54) Dust Mask

(75) Inventor: Jeremiah Schwarz, Weston, CT (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GOODY PRODUCTS, INC., Freeport, IL (US)

(21) Appl. No.: 11/563,448

(22) Filed: Nov. 27, 2006

(51) Int. Cl. A41D 13/11; B23P 11/00

(52) U.S. Cl. 128/863; 29/428

(57) ABSTRACT

The invention is directed to a scented dust mask configured to provide a pleasant scent while being worn on the face of a user. The dust mask includes outer and inner layers of material shaped to cover the nose and mouth of the user, and connected to each other about the outer edges such that the layers of material define a pocket therebetween. The layers of material are configured to filter particulate matter from the air as the air passes through the material. The dust mask further includes a quantity of a scented material disposed and retained within the pocket defined by the inner and outer layers of material, with the scent of the scented material being detectable by the user when the dust mask is worn. The dust mask may further include a connection mechanism configured to retain the dust mask against the face of the user when the dust mask is worn.

### FIELD OF THE DISCLOSURE

The present disclosure is generally directed to dust masks and, more particularly, to dust masks having pockets with scented materials disposed therein with the scent of the scented materials being olfactory detectable by those wearing the dust masks.

### BACKGROUND OF THE DISCLOSURE

Construction workers and others within the construction industry are often exposed to adverse working conditions, including conditions wherein harmful dust particles are present in the air. The harmful agents in the air may result in long term lung damage and may be fatal in the long term. Similar conditions exist in other work areas having adverse working conditions such as coal mines, ship building yards, steel and iron manufacturing plants, wheat milling houses, fiber manufacturing factories, cement manufacturing plants, spray coating places and the like.

Generally, dust-proof masks are used in such environments wherein the air contains a lot of dust to prevent the inhaling of dust through the respiratory channel of the human. Simple dust masks are provided in the form of a hump-shaped, pliant layer of filter material formed to have an irregularly shaped perimeter to conform relatively closely to a person's face to form an enclosure about the person's nose and mouth, and include straps that surround the user's head and neck or ears to hold the dust mask in place. These masks may be fabricated from natural fibers such as cotton and wool, or chemical fibers such as nylon, polyester, acrylonitrile, polypropylene, polyethylene and like that are capable of filtering dust particles and other particulate matter while allowing air to flow through and be inhaled by the user. Other dust-proof masks employ one or more filters on the front or side thereof, i.e., at the air inhaling path so as to capture dust particles. In either form, the dust-proof mask should have a low resistance against inhaling and exhaling by the user while at the same time being high in dust and particle capturing efficiency.

Despite the benefits of wearing masks that are capable of filtering the dust particles present in the construction worksites and other hazardous working environments, many workers in these environments do not wear dust masks or respirators at all, or at least as often as they should be worn. Among the reasons for not wearing dust masks given by these works include the appearance of wearing a mask, the discomfort felt while wearing the mask, and an unpleasant smell emanating from the mask under certain conditions such as when the weather is muggy. For these reasons, a need exists for a dust mask that will provide additional incentive for use by construction workers and others exposed to adverse environmental conditions, or at a minimum reduce the disincentives to wearing dust masks.

### SUMMARY OF THE INVENTION

In one aspect, the invention is directed to a dust mask configured to be worn on the face of a user. The dust mask may include an outer layer of material having an outer edge and being configured to filter particulate matter from the air as the air passes through the outer layer of material, and an inner layer of material having an outer edge and being configured to filter particulate matter from the air as the air passes through the inner layer of material. The outer and inner layers of material may be shaped to cover the nose and mouth of a user of the dust mask, and may be connected to each other about the outer edges such that the inner and outer layers of material define a pocket therebetween. The dust mask may also include a quantity of a scented material disposed and retained within the pocket defined by the inner and outer layers of material, wherein the scent of the scented material is detectable on the exterior of the inner and outer layers of material when air passes through the layers of material. The dust mask may further include a connection mechanism attached to at least one of the inner and outer layers of material and configured to engage the head of a user of the dust mask when the inner layer of material is placed over the nose and mouth of the user to retain the dust mask against the face of the user.

In another aspect, the invention is directed to a dust mask configured to be worn on the face of a user. The dust mask may include a right shell section comprising four pieces of almond-shaped fabric having curved inner edges and curved outer edges, and a left shell section comprising four pieces of almond-shaped fabric having curved inner edges and curved outer edges, wherein the fabric from which the pieces of the right and left shell sections may be configured to filter particulate matter from the air as the air passes through the pieces of fabric. The outer edges of the pieces of fabric of the right shell section are connected together, the outer edges of the pieces of fabric of the left shell section are connected together, and the inner edges of the pieces of fabric of the left and right shell sections are connected together such that facing surfaces of the middle pieces of fabric of the right shell section define a right pocket portion therebetween and facing surfaces of the middle pieces of fabric of the left shell section define a left pocket portion therebetween. The dust mask also includes a first quantity of a scented material disposed and retained within the right pocket portion, and a second quantity of the scented material disposed and retained within the left pocket portion, wherein the scent of the scented material is detectable on the exterior of the left and right shell sections when air passes through the pieces of fabric. The dust mask may further include a connection mechanism attached to the outer edges of the right and left shell sections and configured to engage the head of a user of the dust mask when the inner layer of material is placed over the nose and mouth of the user to retain the dust mask against the face of the user.

In a further aspect, the invention is directed to a method of manufacturing a dust mask having a right shell section comprising four pieces of almond-shaped fabric having curved inner edges and curved outer edges and a left shell section comprising four pieces of almond-shaped fabric having curved inner edges and curved outer edges, wherein the fabric from which the pieces of the right and left shell sections is configured to filter particulate matter from the air as the air passes through the pieces of fabric. The method may include connecting the outer edges of the pieces of fabric of the right shell section to each other, and connecting the outer edges of the pieces of fabric of the left shell section to each other, and separating the inner edges of the middle pieces of fabric of the right and left shell sections to form right and left pocket portions, respectively, between facing surfaces of the middle pieces of fabric. The method may further include depositing a first quantity of a scented material in the right pocket portion and a second quantity of the scented material in the left pocket portion, wherein the scent of the scented material is detectable on the exterior of the left and right shell sections when air passes through the pieces of fabric, and connecting the inner edges of the pieces of fabric of the left and right shell sections together such that right and left pocket portions are closed and retain the quantities of the scented material deposited therein.

Additional aspects of the invention are defined by the claims of this patent.

### BRIEF DESCRIPTION OF THE DRAWINGS

Objects, features, and advantages of the present device will become apparent upon reading the following description in conjunction with the drawing figures, in which:

FIG. 1 is a perspective view of an embodiment of a dust mask in accordance with the present disclosure disposed on the face of a user;

FIG. 2 is a perspective view of the components of the dust mask of FIG. 1;

FIG. 3 is a perspective view of the fabric sections of the dust mask of FIG. 1 being sewn together along the outer edges;

FIG. 4 is a perspective view of a scented material of the dust mask of FIG. 1 being deposited in the pockets formed between the fabric sections of the dust mask; and

FIG. 5 is a perspective view of the completely assembled dust mask of FIG. 1.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the disclosure.

### DETAILED DESCRIPTION OF THE DISCLOSURE

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

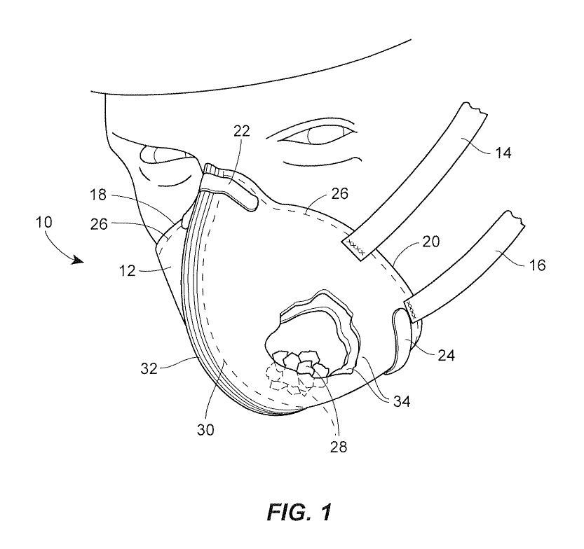

Referring to FIG. 1, an embodiment of a scented dust mask 10 in accordance with the present disclosure is illustrated. The dust mask 10 includes a hump-shaped shell 12 configured to cover the nose and mouth of a person wearing the dust mask 10. The dust mask 10 further includes a pair of straps 14, 16 having ends attached to the outer edges 18, 20 of the shell 12. The straps 14, 16 may be elastic and configured to wrap around the head of the user to hold the outer edges 18, 20 of the shell 12 against the face of the user about the nose and mouth. To further secure the dust mask 10 and conform the shell 12 to the face of the user, the shell 12 may have a nose strip 22 attached to the outer surface of the shell 12 proximate an upper edge. The nose strip 22 may be fabricated from aluminum or a similar metal, from plastic, or from any other appropriate material that may be shaped to conform to the shape of the nose of the user. Similarly, jaw strips 24 may be attached on opposite sides of the shell 12 proximate the bottom edge, and may serve to conform the bottom of the shell 12 more closely to the shape of the jaws of the user.

In order to provide a pleasant scent for the user of the dust mask 10, the shell 12 may be formed from inner and outer layers of fabric attached such that a pocket is formed therebetween. A scented material 28 is disposed within the pocket such that the aroma of the scented material 28 is detectable by the user when the user inhales. As shown in FIG. 1, the inner layer and outer layer of the shell 12 may be attached by stitches 26 around the entire outer edges 18, 20 of the shell 12. To further dispose the scented material 28 proximate the nostrils of the user when the dust mask 10 is worn, the shell 12 may further include stitches 30 down the center 32 of the shell 12 to divide the pocket into lateral sections. As shown by the cutaway portion of the shell 12 in FIG. 1, the shell 12 may be formed from multiple layers of fabric or other filtering materials if necessary to regulate the strength of the scent provided through the dust mask 10, as well as the ability of the chosen material to filter the dust and other particulate matter as the air passes through the shell 12 when the user inhales. While not shown, a one-way valve may be provided on one side of the shell 12 if necessary to provide full ventilation of the carbon dioxide expelled into the inside of the dust mask 10 when the user exhales.

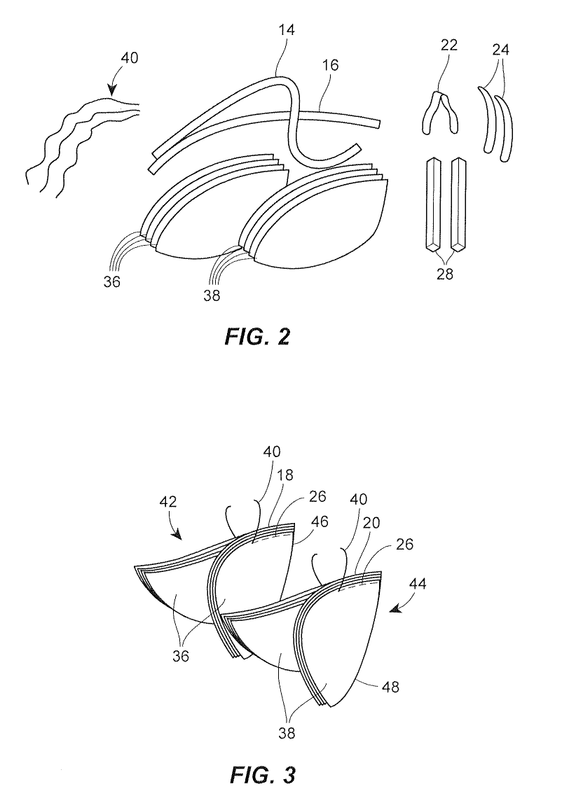

FIGS. 2-5 illustrate one embodiment of the dust mask 10 in accordance with the present disclosure, the components thereof, and a method for manufacturing the dust mask 10. Referring to FIG. 2, the components of the dust mask 10 are shown. The dust mask 10 may include straps 14, 16, nose strip 22, jaw strips 24 and scented material 28 as discussed above. In this embodiment, the shell 12 may be formed from a plurality of right fabric panels 36 and left fabric panels 38 that may be stitched together with thread 40 to form the shell 12. As shown and described below, the dust mask 10 may include four right fabric panels 36 and a corresponding four left fabric panels 38.

As shown in FIG. 2, the fabric panels 36, 38 may be almond-shaped to facilitate forming the hump-shaped shell 12 during the manufacturing process described below. The panels 36, 38 may be fabricated from natural fibers such as cotton and wool, or chemical fibers such as nylon, polyester, acrylonitrile, polypropylene, polyethylene and like that are capable of filtering dust particles and other particulate matter while allowing air to flow through and be inhaled by the user. In the illustrated embodiment, each of the fabric panels 36, 38 is fabricated from woven cotton fibers. However, if necessary for use in a particular environment or for particular users, a combination of materials may be used to achieve a desired performance of the dust mask 10. For example, the inner and outer panels 36, 38 may be fabricated from cotton to provide a comfortable feel when the dust mask 10 is worn, and may be colored white to provide a visual indication that the dust mask 10 is becoming saturated as the color of the outer panels 36, 38 changes from white to the darker color of the dust present in the air being filtered by the dust mask 10. In the same dust mask 10, the inner or middle layers of the inner and outer panels 36, 38 may be fabricated from a chemical fiber and with a configuration that filters a specific type of particulate matter that may be present in the particular environment in which the dust mask 10 is being used, or that is appropriate for storing the particular scented material 28 stored in the pocket of the dust mask 10. Those skilled in the art will understand that other combinations of fabric panels 36, 38 may be implemented, and that such combinations are contemplated by the inventor as having use in dust masks 10 in accordance with the present disclosure.

As discussed above, the straps 14, 16 may be elastic bands that may stretch to encircle the head of the user when the dust mask 10 is worn to secure the edges 18, 20 of the shell 12 against the face of the user. Alternatively, and in particular when the panels 36, 38 of the shell 12 are formed from a material having some resiliency or elasticity, the straps 14, 16 may be formed from an inelastic material. The straps 14, 16 may have a length that will allow the dust mask 10 to fit the heads of a majority of the potential users of the dust mask 10 as the shell 12 stretches due to the elasticity of the material from which the panels 36, 38 of the shell 12 are formed. As a further alternative, the straps 14, 16 may be in the form of pairs of laces wherein each lace forming the strap 14 or 16 may have one end connected to a corresponding one of the outer edges 18, 20, and with the other end being unattached so that the laces may be tied behind the head of the user to secure the shell 12 against the face of the user.

In addition, while the straps 14, 16 are illustrated herein with the ends of the strap 14 being attached to the outer edges 18, 20 of the shell 12 above the ends of the strap 16, other configurations of the straps 14, 16 are possible. For example, both ends of the strap 14 may be attached to the outer edge 18, and both ends of the strap 16 may be attached to the outer edge 20. In this configuration, when the dust mask 10 is worn, the strap 14 may be looped around the right ear of the user and the strap 16 may be looped around the left ear of the user to retain the shell 12 in place over the nose and mouth of the user. As a further alternative, one end of the strap 14 may be attached to an upper portion of the outer edge 18 and to a lower portion of the outer edge 20, and vice versa for the strap 16 such that the straps 14, 16 cross behind the head of the user when the dust mask 10 is worn. Of course, other configurations of the straps 14, 16 are possible and are contemplated by the inventor as having use in dust masks 10 in accordance with the present disclosure.

The scented material 28 may be any material providing a desired aroma to the user through the inner panels 36, 38 when the dust mask 10 is worn. Examples of scents that may be provided in the dust masks 10 in accordance with the present disclosure include menthol, cedar, cinnamon, orange, lemon, mint, vanilla, lavender and the like. Of course, other scents may be provided in the dust masks 10 as desired. Depending on the scent being provided and the characteristics of the source of the scent, the scented material 28 may be in any appropriate form of material from which the particular scent may emanate in a level that is detectable by the user but not overly abundant so as to overwhelm the user. Some scents may be provided by the most natural form of the material to yield the desired strength of the scent when the user inhales. For example, the scented material 28 may be in the form of ground up bark of the evergreen trees from which cinnamon is derived, small chips of cedar wood and/or bark, sprigs of peppermint or lavender buds. Other scents may require a form other than their natural form so that the scented materials 28 may be contained within the pockets of the shell 12 without too strong of a scent when the user inhales. Consequently, lemon and orange scents may be provided by small beads or chunks of material having an additive producing the lemon or orange scents in lieu of enclosing sections or peel portions of the fruits within the pockets of the dust mask 10. Those skilled in the art will be able to determine and implement the proper scented material 28 for a particular scent to be provided by and implemented in a scented dust mask 10 in accordance with the present disclosure.

The dust mask 10 having the components illustrated in FIGS. 1 and 2 may be manufactured, for example, via the steps shown in FIGS. 3-5. For purposes of this illustrative discussion, the right and left fabric panels 36, 38, respectively, are almond-shaped pieces of cotton material. Turning to FIG. 3, the manufacturing process for the dust mask 10 may begin by sewing together the right fabric panels 36 with the thread 40 along one of the curved edges to form the outer edge 18 of the shell 12, and sewing together the left fabric panels 38 with the thread 40 along one of the curved edges to form the outer edge 20. By sewing the panels 36, 38 together along one edge, a right shell section 42 and left shell section 44 are formed having inner edges 46, 48, respectively.

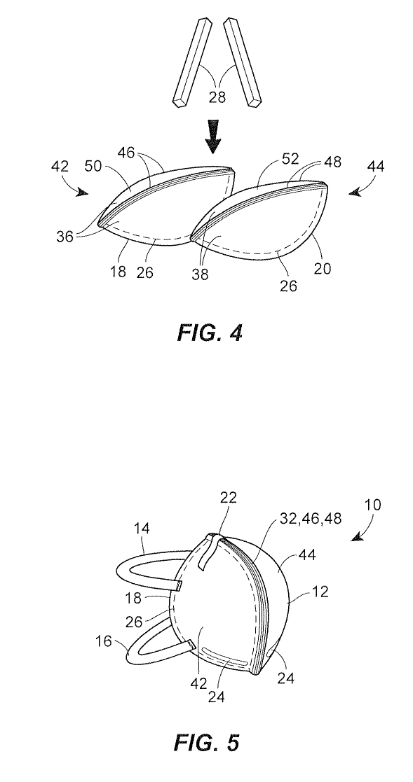

As shown in FIG. 4, each shell section 42, 44 receives a quantity of the scented material 38 therein. In the illustrated embodiment, the inner edges 46, 48 of the fabric panels 36, 38, respectively, are pulled apart such that the middle fabric panels 36, 38 form right and left pocket portions 50, 52, respectively, for receiving the scented material 38. A sufficient quantity of the scented material 38 is deposited in the pocket portions 50, 52 to provide a desired strength of the scent when the user inhales. Again, the use of four fabric panels 36, 38 is exemplary and fewer or more fabric panels 36, 38 may be provided as necessary or desired to form the shell sections 42, 44 and, ultimately, the shell 12, and the pockets for receiving and retaining the scented material 38.

After the scented material 38 is deposited in the pocket portions 50, 52 of the shell sections 42, 44, respectively, manufacturing of the dust mask 10 may be completed as shown in FIG. 5. To enclose the pocket portions 50, 52 of the shell sections 42, 44, respectively, the shell sections 42, 44 are connected by sewing the sections 42, 44 together along the inner edges 46, 48, respectively, of all the panels 36, 38 with the thread 40 to form the stitches 30 along the centerline 32 of the shell 12. With the inner edges 46, 48 sewn together, the scented material 28 is retained within the pocket portions 50, 52 during use. To further shape the shell 12 to conform to the shape of the face of a user, the nose strip 22 is attached to the shell 12 about the centerline 32 proximate the top of the shell 12, and the jaw strips 24 are attached on either side of the centerline 32 proximate the bottom of the shell 12. The strips 22, 24 may be attached to the shell 12 via an adhesive or any other appropriate attachment mechanism such that the strips 22, 24 contour the portions of the shell 12 to which they are attached to the corresponding features of the user of the dust mask 10. Finally, the straps 14, 16 are attached to the outer edges 18, 20 via stitching, staples, adhesive, or any other appropriate attachment mechanism.

Once the dust mask 10 is manufactured, the user may don the dust mask 10 by separating the outer edges 18, 20 sufficiently for the shell 12 to enclose the nose and mouth of the user, pulling the straps 14, 16 over the head, and disposing the shell 12 over the nose and mouth and in contact with the portion of the face of the user surrounding the nose and mouth. For purposes of packaging and identification by the user of the scent provided by the dust mask 10, the dust mask 10 may provide a visual indication of the type of scented material 28 contained therein. Consequently, the name of the scent or a colored-coded label corresponding to the scent may be printed on the outside of the shell 12. Alternatively, the dust mask 10 may be manufactured with the thread 40 having a distinctive color corresponding to the scented material 28 retained within the pocket of the shell 12 by the thread 40. Still further, other color coding on the dust mask 10 itself, such as distinctive coloring of the straps 14, 16 or the fabric from which the outer panels 36, 38 are fabricated, attachment of a color coded label to the dust mask 10, and the like, may be used to allow the user to quickly identify the scent provided by the dust mask 10 without the necessity of sniffing the dust mask 10 and possibly inhaling a scent that, based on the personal preferences of the user, is unpleasant.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed is:

1. A dust mask configured to be worn on the face of a user, comprising:
an outer layer of material having an outer edge and being configured to filter particulate matter from the air as the air passes through the outer layer of material;
an inner layer of material having an outer edge and being configured to filter particulate matter from the air as the air passes through the inner layer of material, wherein the outer and inner layers of material are shaped to cover the nose and mouth of a user of the dust mask, and wherein the outer and inner layers of material are connected to each other about the outer edges such that the inner and outer layers of material define a pocket therebetween;
a quantity of a scented material disposed and retained within the pocket defined by the inner and outer layers of material, wherein the scent of the scented material is detectable on the exterior of the inner and outer layers of material when air passes through the layers of material; and
a connection mechanism attached to at least one of the inner and outer layers of material and configured to engage the head of a user of the dust mask when the inner layer of material is placed over the nose and mouth of the user to retain the dust mask against the face of the user.

2. A dust mask in accordance with claim 1, wherein the scent provided by the scented material is one of menthol, cedar, cinnamon, orange, lemon, mint, vanilla and lavender.

3. A dust mask in accordance with claim 1, wherein the inner and outer layers of material are cotton fabrics.

4. A dust mask in accordance with claim 1, wherein the inner and outer layers of material each comprise two pieces of almond-shaped fabric having curved outer edges and curved inner edges, wherein the inner edges of the inner layer are connected together, the inner edges of the outer layer are connected together, and outer edge of each of the pieces of the inner layer of material is connected to the outer edge of a corresponding one of the pieces of the outer layer of material.

5. A dust mask in accordance with claim 4, wherein the inner edges of each of the pieces of fabric are connected together such that the pocket defined by the inner and outer layers of material is divided into left and right pocket portions, with each pocket portion having a corresponding portion of the quantity of scented material disposed therein.

6. A dust mask in accordance with claim 1, wherein the inner and outer layers of material are stitched together along the outer edges to form the connection therebetween.

7. A dust mask in accordance with claim 1, wherein each of the inner and outer layers of material comprises two pieces of fabric.

8. A dust mask in accordance with claim 1, comprising a nose strip shaped to conform to the nose of a user of the dust mask and connected to the outer layer of material proximate a top edge of the dust mask such that the nose strip is disposed about the nose of the user when the dust mask is worn by the user.

9. A dust mask in accordance with claim 1, wherein the connection mechanism comprises:
a first strap having ends connected on either side of the outer layer proximate the outer edge of the outer layer; and
a second strap having ends connected on either side of the outer layer proximate the outer edge of the outer layer at positions below the ends of the first strap.

10. A dust mask configured to be worn on the face of a user, comprising:
a right shell section comprising four pieces of almond-shaped fabric having curved inner edges and curved outer edges;
a left shell section comprising four pieces of almond-shaped fabric having curved inner edges and curved outer edges, wherein the fabric from which the pieces of the right and left shell sections is configured to filter particulate matter from the air as the air passes through the pieces of fabric, wherein the outer edges of the pieces of fabric of the right shell section are connected together, the outer edges of the pieces of fabric of the left shell section are connected together, and the inner edges of the pieces of fabric of the left and right shell sections are connected together such that facing surfaces of the middle pieces of fabric of the right shell section define a right pocket portion therebetween and facing surfaces of the middle pieces of fabric of the left shell section define a left pocket portion therebetween;
a first quantity of a scented material disposed and retained within the right pocket portion;
a second quantity of the scented material disposed and retained within the left pocket portion, wherein the scent of the scented material is detectable on the exterior of the left and right shell sections when air passes through the pieces of fabric; and
a connection mechanism attached to the outer edges of the right and left shell sections and configured to engage the head of a user of the dust mask when the inner layer of material is placed over the nose and mouth of the user to retain the dust mask against the face of the user.

11. A dust mask in accordance with claim 1, wherein the scent provided by the scented material is one of menthol, cedar, cinnamon, orange, lemon, mint, vanilla and lavender.

12. A dust mask in accordance with claim 1, wherein the pieces of fabric are cotton fabrics.

13. A dust mask in accordance with claim 10, wherein the pieces of fabric are stitched together along the edges to form the connections therebetween.

14. A dust mask in accordance with claim 10, comprising a nose strip shaped to conform to the nose of a user of the dust mask and collected to the outer surface of the right and left shell sections about a centerline of the dust mask formed by the inner edges of the pieces of fabric and proximate a top edge of the dust mask such that the nose strip is disposed about the nose of the user when the dust mask is worn by the user.

15. A dust mask in accordance with claim 10, wherein the connection mechanism comprises:
a first strap having a first end connected proximate the outer edge of the right shell section, and a second end connected proximate the outer edge of the left shell section; and
a second strap having a first end connected proximate the outer edge of the right shell section below the first end of the first strap, and a second end connected proximate the outer edge of the left shell section below the second end of the first strap.

16. A method of manufacturing a dust mask having a right shell section comprising four pieces of almond-shaped fabric having curved inner edges and curved outer edges and a left shell section comprising four pieces of almond-shaped fabric having curved inner edges and curved outer edges, wherein the fabric from which the pieces of the right and left shell sections is configured to filter particulate matter from the air as the air passes through the pieces of fabric, the method comprising:
connecting the outer edges of the pieces of fabric of the right shell section to each other, and connecting the outer edges of the pieces of fabric of the left shell section to each other;
separating the inner edges of the middle pieces of fabric of the right and left shell sections to form right and left pocket portions, respectively, between facing surfaces of the middle pieces of fabric;
depositing a first quantity of a scented material in the right pocket portion and a second quantity of the scented material in the left pocket portion, wherein the scent of the scented material is detectable on the exterior of the left and right shell sections when air passes through the pieces of fabric; and
connecting the inner edges of the pieces of fabric of the left and right shell sections together such that right and left pocket portions are closed and retain the quantities of the scented material deposited therein.

17. A method of manufacturing a dust mask in accordance with claim 16, wherein connecting the inner edges and outer edges of the pieces of fabric comprises stitching the inner and outer edges together.

18. A method of manufacturing a dust mask in accordance with claim 16, comprising:
connecting a first end of a first strap proximate the outer edge of the right shell section, and a second end of the first strap proximate the outer edge of the left shell section; and
connecting a first end of a second strap proximate the outer edge of the right shell section below the first end of the first strap, and a second end of the second strap proximate the outer edge of the left shell section below the second end of the first strap.

19. A method of manufacturing a dust mask in accordance with claim 16, wherein the dust mask includes a nose strip shaped to conform to the nose of a user of the dust mask, the method comprising connecting the nose strip to the outer surface of the right and left shell sections about a centerline of the dust mask formed by the inner edges of the pieces of fabric and proximate a top edge of the dust mask such that the nose strip is disposed about the nose of the user when the dust mask is worn by the user.
